(19) United States
(12) Patent Application Publication
(10) Pub. No.: US 2014/0167897 A1
(43) Pub. Date: Jun. 19, 2014

(54) POWER INDUCTOR AND METHOD OF MANUFACTURING THE SAME

(71) Applicant: SAMSUNG ELECTRO-MECHANICS CO., LTD., Suwon (KR)

(72) Inventors: Dong Hyeok CHOI, Suwon (KR); Sung Yong AN, Suwon (KR); Sung Kwon WI, Suwon (KR); Hak Kwan KIM, Suwon (KR)

(73) Assignee: SAMSUNG ELECTRO-MECHANICS CO., LTD., Suwon (KR)

(21) Appl. No.: 13/840,756

(22) Filed: Mar. 15, 2013

(30) Foreign Application Priority Data
Dec. 14, 2012 (KR) 10-2012-0146029

(51) Int. Cl. H01F 27/255; H01F 41/02

(52) U.S. Cl. CPC H01F 27/255; H01F 41/02
USPC 336/83; 29/605

(57) ABSTRACT

There is provided a power inductor including a coil supporting layer having a through-hole, first and second coil layers formed in a spiral shape on both surfaces of the coil supporting layer, an inductor body having the coil supporting layer and the first and second coil layers buried therein so that end portions of the first and second coil layers are exposed through both end surfaces thereof, and first and second external electrodes formed on both end surfaces of the inductor body, to be connected to the exposed end portions of the first and second coil layers, respectively, wherein in the inductor body, a core formed in the through-hole is formed of a magnetic material including spherical metal powder particles, and upper and lower cover parts are formed of a magnetic material including flake shaped metal powder particles.

### CROSS-REFERENCE TO RELATED APPLICATIONS

This application claims the priority of Korean Patent Application No. 10-2012-0146029 filed on Dec. 14, 2012, in the Korean Intellectual Property Office, the disclosure of which is incorporated herein by reference.

### BACKGROUND OF THE INVENTION

1. Field of the Invention

The present invention relates to a power inductor and a method of manufacturing the same.

2. Description of the Related Art

An inductor, a main passive element configuring an electrical circuit together with a resistor and a capacitor, may be used to remove noise or may be used in a component, or the like, configuring an LC resonance circuit and may be divided into a winding-type inductor, a multilayered-type inductor, and a thin film-type inductor, according to a structure thereof.

Among these, the thin film type inductor may be formed of a material having a high saturation magnetization value. Further, even in the case in which the thin film-type inductor is manufactured to have a small size, it may be easy to form an internal circuit pattern as compared with the multilayered-type inductor. Therefore, recently, research into thin film-type inductors has been actively conducted.

In thin film-type inductors, a magnetic material is used as a material of an inductor body in order to output a high amount of inductance. As the magnetic material, a soft magnetic material having sensitivity to a low magnetic field, a ferrite and a metal may be used.

A direct current (DC) bias of characteristics of a power inductor should be 2A or more for recent smartphone and multi-input multi-output (MIMO) communications. To this end, a high amount of inductance should be implemented even at a high current. However, in existing inductors having a structure formed of a ferrite, since a DC bias may not be high, it may be difficult to satisfy the above-mentioned conditions.

The following Related Art Document, relating to a multilayered type inductor, discloses a feature of dividing soft magnetic metal powder particles into spherical soft magnetic metal powder particles and flake-shaped soft magnetic metal powder particles.

### RELATED ART DOCUMENT

Korean Patent Laid-Open Publication No. 2009-0097303

### SUMMARY OF THE INVENTION

An aspect of the present invention provides a power inductor capable of obtaining a high degree of magnetic permeability while maintaining a high inductance value at a high current.

According to an aspect of the present invention, there is provided a power inductor including: a coil supporting layer having a through-hole formed in the center thereof; first and second coil layers formed to have a spiral shape on both surfaces of the coil supporting layer; an inductor body having the coil supporting layer and the first and second coil layers buried therein so that end portions of the first and second coil layers are exposed through both end surfaces thereof; and first and second external electrodes formed on both end surfaces of the inductor body, respectively, so as to be connected to the exposed end portions of the first and second coil layers, respectively, wherein in the inductor body, a core formed in the through-hole of the coil supporting layer is formed of a magnetic material including spherical metal powder particles, and upper and lower cover parts are formed of a magnetic material including flake shaped metal powder particles.

The spherical metal powder particles included in the core may include at least one of iron (Fe), a nickel-iron alloy (NiFe), an iron-silicon-aluminum alloy (FeSiAl), and an iron-silicon-chrome alloy (FeSiCr).

A diameter of the spherical metal powder particles included in the core may be 2 to 60 μm based on D₅₀ (cutpoint diameter).

The flake shaped metal powder particles included in the upper and lower cover parts may include at least one of iron (Fe), a nickel-iron alloy (NiFe), an iron-silicon-aluminum alloy (FeSiAl), and an iron-silicon-chrome alloy (FeSiCr).

A thickness of a short side of the flake shaped metal powder particles included in the upper and lower cover parts may be 3 μm or less.

Ratios of short sides to long sides of the flake shaped metal powder particles included in the upper and lower cover parts may be 1:3 to 1:100.

The ratio of the short side to the long side of the flake shaped metal powder particles included in the upper cover part may be different from that of the flake shaped metal powder particles included in the lower cover part.

The coil supporting layer may be configured of a substrate formed of an insulating or magnetic material.

A thickness of the coil supporting layer may be 80 to 160 μm.

The first and second coil layers may have an insulating film formed along circumferences thereof.

According to another aspect of the present invention, there is provided a method of manufacturing a power inductor, including: preparing a substrate formed of an insulating or magnetic material and having a through-hole formed in the center thereof; forming first and second coil layers in a spiral shape on both surfaces of the substrate, respectively, so that end portions thereof are exposed through both end surfaces; disposing the substrate having the first and second coil layers formed thereon on a lower cover part formed of a magnetic material including flake shaped metal powder particles; filling a magnetic material including spherical metal powder particles in the through-hole of the substrate to form a core; disposing an upper cover part on the substrate to manufacture an inductor body, the upper cover part being formed of a magnetic material including the flake shaped metal powder particles; and forming first and second external electrodes so as to cover both end surfaces of the inductor body, respectively, to thereby be connected to the exposed end portions of the first and second coil layers, respectively.

The method may further include, before the disposing of the substrate, covering a circumference of the substrate using an insulating material so as to enclose surfaces of the first and second coil layers.

In the disposing of the substrate, a plurality of substrates each having the first and second coil layers may be multilayered on the lower cover part.

In the disposing of the upper cover part, at least one cover sheet formed of a magnetic material including the flake shaped metal powder particles may be multilayered on the substrate.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view of an inductor according to an embodiment of the present invention; and

FIG. 2 is a cross-sectional view taken along line A-A′ of FIG. 1.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein.

Rather, these embodiments are provided so that this disclosure will be thorough and complete, and will fully convey the scope of the invention to those skilled in the art.

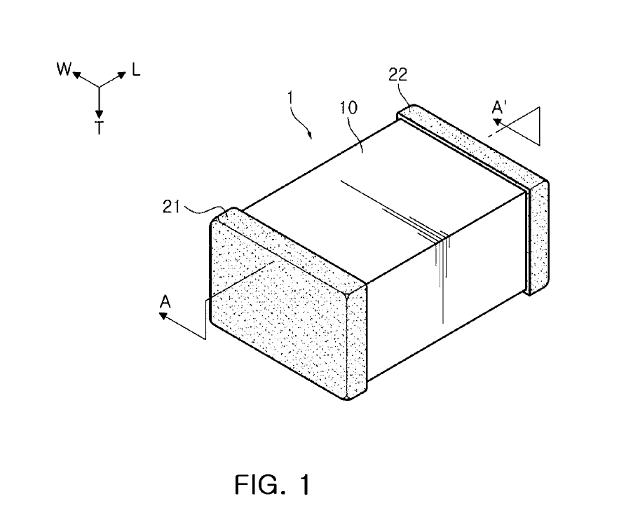

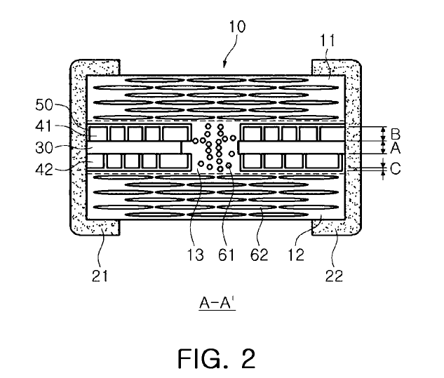

Referring to FIGS. 1 and 2, an inductor 1 according to an embodiment of the present invention may include an inductor body 10 and first and second external electrodes 21 and 22 formed on both end surfaces of the inductor body 10.

Hereinafter, an “L direction”, a “W direction”, and a “T direction” in FIG. 1 refer to a “length direction”, a “width direction”, and a “thickness direction”, respectively.

The first and second external electrodes 21 and 22 may be formed of a metal having electrical conductivity, for example, at least one metal selected from a group consisting of gold, silver, platinum, copper, nickel, palladium, and an alloy thereof.

Here, when necessary, a nickel plated layer (not shown) or a tin plated layer (not shown) may be further formed on surfaces of the first and second external electrodes 21 and 22.

The inductor body 10 may have a rectangular parallelepiped shape and include upper and lower cover parts 11 and 12 formed of a magnetic material and a core formed in a through-hole of a coil supporting layer to be described below and formed of a magnetic material.

The upper and lower cover parts 11 and 12 may have a coil supporting layer 30 disposed therebetween, wherein the coil supporting layer 30 has a central through-hole, which becomes a core 13. The coil supporting layer 30 may have first and second coil layers 41 and 42 formed on both surfaces thereof, wherein the first and second coil layers 41 and 42 have end portions exposed through both end surfaces of the inductor body 10 to thereby be electrically connected to the first and second external electrodes 21 and 22, respectively.

The upper and lower cover part 11 and 12 may basically serve to prevent electrical characteristics of the first and second coil layers 41 and 42 from being deteriorated.

The upper and lower cover part 11 and 12 may be formed of a paste including a composite of metal powder particles such as ferrites, or the like, and a polymer, or be formed of a substrate including metal powder particles.

The metal powder particles may be a flake shaped metal powder particles 62 including at least one of iron (Fe), a nickel-iron alloy (Ni—Fe), sendust (Fe—Si—Al), and an iron-silicon-chrome alloy (Fe—Si—Cr).

Since the metal powder particles generally have a small chip size, a magnetic material including spherical metal powder particles may be used in order to increase a filling ratio. However, since the spherical metal powder particles have a demagnetizing field corresponding to about ⅓, the flake shaped metal powder particles generated by changing shapes of the metal powder particles as described above may be used in the upper and lower cover parts 11 and 12 having a relatively wide filling area. In the case in which a magnetic material including the flake shaped metal powder particles 62 as described above is used, magnetic permeability of the inductor may be increased.

In addition, in the case in which the metal powder particles have the flake shape, since insulation between the powder particles is easily obtained using resin and epoxy, inductance efficiency may be improved.

Here, a thickness of a short side of the flake shaped metal powder particles 62 may be 3 μm or less.

The following Tablet shows thicknesses of sheets casted using various flake shaped metal powder particles 62 and inductances of power inductors using the sheets.

TABLE 1

| | Lₛ inductance (μH) | | | | |
|---|---|---|---|---|---|
| Flake shaped | Flake shaped | | | | |
| metal powder | metal powder | | | | |
| layer (mm) | is not used | 0.1 | 0.2 | 0.3 | 0.4 |
| Sample 1 | 0.83 | 0.87 | 0.91 | 1.01 | 0.96 |
| Sample 2 | 0.84 | 0.86 | 0.92 | 0.98 | 0.96 |
| Sample 3 | 0.83 | 0.88 | 0.94 | 0.97 | 0.97 |
| Sample 4 | 0.82 | 0.86 | 0.93 | 1.00 | 0.93 |
| Sample 5 | 0.83 | 0.87 | 0.93 | 0.98 | 0.95 |

In the case in which the thickness of the short side of the flake shaped metal powder particles 62 exceeds 3 μm, core loss, that is, eddy current loss is increased in the metal powder particles, such that inductance efficiency is deteriorated.

In addition, a ratio of a short side to a long side of the flake shaped metal powder particles 62 may be 1:3 or more to 1:100 or less. In the case in which the ratio of the short side to the long side of the flake shaped metal powder particles 62 is less than 1:3, the flake shaped metal powder particles 62 may not be considered to be a flake shaped powder particles and it may be difficult to fill the flake shaped metal powder particles 62 in a multilayered form.

Further, in the case in which the ratio of the short side to the long side of the flake shaped metal powder particles 62 exceeds 1:100, a phenomenon in which the upper and lower cover parts 11 and 12 are bent or folded due to softness of the flake shaped metal powder particles 62 occurs, such that it may be difficult to densely fill the flake shaped metal powder particles 62.

The coil supporting layer 30 may be manufactured using a substrate formed of an insulating material such as a photosensitive polymer or a magnetic material such as a ferrite, or the like.

Here, a thickness A of the coil supporting layer 30 may be 80 to 160 μm. In the case in which the thickness of the coil supporting layer 30 is less than 80 μm, specific resistance (R_{dc}) for the overall coil is relatively high, such that the overall efficiency of the power inductor may be deteriorated, and in the case in which the thickness of the coil supporting layer 30 exceeds 160 μm, it may be likely to cause a short-circuit, or the like, at the time of plating the coil.

In addition, the first and second coil layers 41 and 42 adjacent to each other may have a photosensitive insulating material interposed therebetween and may be electrically connected to each other by a conductive via (not shown).

Here, the conductive via may be formed by forming a through-hole (not shown) in the coil supporting layer 30 in the thickness direction so as to penetrate through the coil supporting layer 30 and filling the through-hole with a conductive paste.

The core 13 of the inductor body 10 may be formed of a paste including a composite of metal powder particles such as ferrites, or the like, and a polymer.

The metal powder particles may be spherical powder particles 61 including at least one of iron (Fe), a nickel-iron alloy (Ni—Fe), sendust (Fe—Si—Al), and an iron-silicon-chrome alloy (Fe—Si—Cr).

Since the core 13 has a filling area smaller than those of the upper and lower cover parts 11 and 12, it may be formed of a magnetic material including the spherical metal powder particles in order to increase a filling ratio.

Here, a diameter of the spherical powder particles 61 may be 2 to 60 μm.

In the case in which the diameter of the spherical powder particles 61 is less than 2 μm, a specific surface area of the spherical powder particles 61 is relatively high. Therefore, since a relatively large amount of pressure needs to be applied in order to densely fill the spherical powder particles 61 in the core 13, a filling ratio may be decreased.

Further, in the case in which the diameter of the spherical powder particles 61 exceeds 60 μm, large powder particles are precipitated at the time of producing a metal powder slurry, such that a problem in view of dispersion may occur. That is, when small particles and large particles are linearly dispersed, the spherical powder particles 61 having the large diameter as described above are precipitated, that is, settled in a slurry, such that the particles may not be uniformly dispersed.

The first and second coil layers 41 and 42 formed on the coil supporting layer 30 may generally have a spiral structure, that is, may have a polygonal shape such as a quadrangular shape, a pentagonal shape, a hexagonal shape, or the like, a circular shape, an oval shape, or the like, and have an irregular shape as needed.

However, as shown in FIGS. 1 and 2, in the case in which the inductor body 10 has a rectangular parallelepiped shape, when the first and second coil layer 41 and 42 have a quadrangular shape, areas of the first and second coil layers 41 and 42 are significantly increased, such that strength of induced magnetic fields may be significantly increased.

Here, a thickness A of the coil supporting layer 30 may be 80 to 160 μm.

In the case in which the thickness of the coil supporting layer 30 is less than 80 μm, specific resistance (R_{dc}) for the overall coil is relatively high, such that the overall efficiency of the power inductor may be deteriorated, and in the case in which the thickness of the coil supporting layer 30 exceeds 160 μm, it may be likely to cause a short-circuit, or the like, at the time of plating the coil.

One ends of the first and second coil layers 41 and 42 may be led to one end portion of the coil supporting layer 30, respectively, to thereby be electrically connected to the first and second external electrodes 21 and 22, respectively.

In addition, the other ends of the first and second coil layers 41 and 42 may be positioned in the vicinity of the center of the coil supporting layer 30 and be electrically connected to each other by a via conductor (not shown), or the like.

The first and second coil layers 41 and 42 may include at least one metal selected from a group consisting of gold, silver, platinum, copper, nickel, palladium, and an alloy thereof. However, the first and second coil layers 41 and 42 according to the embodiment of the present invention may also include any material having electrical conductivity. Therefore, the first and second coil layers 41 and 42 according to the embodiment of the present invention are not limited to being formed of the above-mentioned metals.

Meanwhile, in order to insulate between the first and second coil layers 41 and 42 and the inductor body 10, the first and second coil layers 41 and 42 may have an insulating film 50 formed along circumferences thereof so as to enclose surfaces thereof.

The insulating film 50 may be formed of a material having insulating properties, for example, a polymer, or the like. However, the present invention is not limited thereto.

Hereinafter, a method of manufacturing a power inductor according to the embodiment of the present invention will be described.

First, a substrate formed of an insulating material or a magnetic material may be prepared. Here, since the substrate indicates the same component as the coil supporting layer described above, it will be denoted by a reference numeral 30. The substrate 30 may have a through-hole formed in the center thereof in order to form a core therein.

Then, the first and second coil layers 41 and 42 may be formed in a spiral shape on both surfaces of the substrate 30, respectively, so that end portions thereof are exposed through both end surfaces.

The first and second coil layers 41 and 42 may be formed in a sequence of plating one surface of the substrate 30 with a conductive paste to form the first coil layer 41, forming a conductive via (not shown) penetrating through the substrate 30, and plating an opposite surface to the surface having the first coil layer 41 formed thereon with a conductive paste to form the second coil layer 41.

Here, the first and second coil layers 41 and 42 may be electrically connected to each other by the conductive via.

The conductive via may be formed by forming a through-hole in the thickness direction of the substrate 30 using a laser device, a punching device, or the like, and then filling the through-hole with a conductive paste.

In addition, the conductive paste may include a metal having electrical conductivity, for example, at least one metal selected from a group consisting of gold, silver, platinum, copper, nickel, palladium, and an alloy thereof.

Here, all the first and second coil layers 41 and 42 and the conductive via may be formed of the same material in order to provide more stably electrical characteristics.

Next, the substrate 30 having the first and second coil layers 41 and 42 formed thereon may be disposed on the lower cover part 12 formed of a magnetic material including the flake shaped metal powder particles 62.

A plurality of substrates 30 may be stacked in the thickness direction of the inductor body 10, and one end portions of the first or second coil layers 41 or 42 of the substrates 30 adjacent thereto in a direction in which the substrates 30 are stacked may be configured to contact each other through a via conductor (not shown) to thereby be electrically connected to each other.

Here, since the second coil layer 42 is formed in the spiral shape to have relatively high contact force, adhesion between the second coil layer 42 and the lower cover part 12 may be improved.

In addition, the first and second coil layers 41 and 42 may have the insulating film 50 formed along circumferences thereof using a material such as a polymer having insulating properties so as to enclose surfaces thereof.

Thereafter, a magnetic material including the spherical metal powder particles 62 may be filled in the through-hole of the substrate 30 to form the core 13.

Then, the upper cover part 11 formed of a magnetic material including the flake shaped metal powder particles 62 may be disposed on the substrate 30 to complete the inductor body 10.

The upper cover part 11 may be formed by further multi-layering at least one cover sheet on the substrate 30 or casting a paste formed of the same material as that of the cover sheet on the substrate 20 to have a predetermined thickness so as to increase filling density.

Here, since the first coil layer 41 is formed in the spiral shape to have relatively high contact force, adhesion between the first coil layer 41 and the upper cover part 11 may be improved.

Next, the first and second external electrodes 21 and 22 may be formed on both end surfaces of the inductor body 10, respectively, so as to be electrically connected to the exposed end portions of the first and second coil layers 41 and 42, respectively.

Here, the first and second external electrodes 21 and 22 may be formed by a method of immersing the inductor body 10 in a conductive paste, a method of printing, depositing, and sputtering a conductive paste on both end surfaces of the inductor body 10, or the like.

The conductive paste may include a metal capable of imparting electrical conductivity to the first and second external electrodes 21 and 22, for example, at least one metal selected from a group consisting of gold, silver, platinum, copper, nickel, palladium, and an alloy thereof.

In addition, when necessary, a nickel plated layer (not shown) or a tin plated layer (not shown) may be further formed on surfaces of the first and second external electrodes 21 and 22.

As set forth above, according to the embodiments of the present invention, in a thin film type inductor, the core part of the inductor body includes the spherical metal powder particles, and the upper and lower cover parts formed on the upper and lower portions of the inductor body include the flake shaped metal powder particles, whereby relatively high magnetic permeability may be obtained while maintaining a relatively high inductance value at a high current.

While the present invention has been shown and described in connection with the embodiments, it will be apparent to those skilled in the art that modifications and variations can be made without departing from the spirit and scope of the invention as defined by the appended claims.

What is claimed is:

1. A power inductor comprising:
a coil supporting layer having a through-hole formed in the center thereof;
first and second coil layers formed in a spiral shape on both surfaces of the coil supporting layer;
an inductor body having the coil supporting layer and the first and second coil layers buried therein so as to allow end portions of the first and second coil layers to be exposed through both end surfaces thereof; and
first and second external electrodes formed on both end surfaces of the inductor body, respectively, so as to be connected to the exposed end portions of the first and second coil layers, respectively,
wherein in the inductor body, a core formed in the through-hole of the coil supporting layer is formed of a magnetic material including spherical metal powder particles, and upper and lower cover parts are formed of a magnetic material including flake shaped metal powder particles.

2. The power inductor of claim 1, wherein the spherical metal powder particles included in the core includes at least one of iron (Fe), a nickel-iron alloy (NiFe), an iron-silicon-aluminum alloy (FeSiAl), and an iron-silicon-chrome alloy (FeSiCr).

3. The power inductor of claim 1, wherein a diameter of the spherical metal powder particles included in the core is 2 to 60 μm based on D₅₀ (cutpoint diameter).

4. The power inductor of claim 1, wherein the flake shaped metal powder particles included in the upper and lower cover parts includes at least one of iron (Fe), a nickel-iron alloy (NiFe), an iron-silicon-aluminum alloy (FeSiAl), and an iron-silicon-chrome alloy (FeSiCr).

5. The power inductor of claim 1, wherein a thickness a short side of the flake shaped metal powder particles included in the upper and lower cover parts is 3 μm or less.

6. The power inductor of claim 1, wherein ratios of short sides to long sides of the flake shaped metal powder particles included in the upper and lower cover parts are 1:3 to 1:100.

7. The power inductor of claim 6, wherein the ratio of the short side to the long side of the flake shaped metal powder particles included in the upper cover part is different from that of the flake shaped metal powder particles included in the lower cover part.

8. The power inductor of claim 1, wherein the coil supporting layer is configured of a substrate formed of an insulating or magnetic material.

9. The power inductor of claim 1, wherein a thickness of the coil supporting layer is 80 to 160 μm.

10. The power inductor of claim 1, wherein the first and second coil layers have an insulating film formed along circumferences thereof.

11. A method of manufacturing a power inductor, comprising:
preparing a substrate formed of an insulating or magnetic material and having a through-hole formed in the center thereof;
forming first and second coil layers in a spiral shape on both surfaces of the substrate, respectively, so as to allow end portions thereof to be exposed through both end surfaces;
disposing the substrate having the first and second coil layers formed thereon, on a lower cover part formed of a magnetic material including flake shaped metal powder particles;
filling a magnetic material including spherical metal powder particles in the through-hole of the substrate to form a core;
disposing an upper cover part on the substrate to manufacture an inductor body, the upper cover part being formed of a magnetic material including the flake shaped metal powder particles; and
forming first and second external electrodes so as to cover both end surfaces of the inductor body, respectively, to thereby be connected to the exposed end portions of the first and second coil layers, respectively.

12. The method of claim 11, further comprising, before the disposing of the substrate, covering a circumference of the substrate using an insulating material so as to enclose surfaces of the first and second coil layers.

13. The method of claim 11, wherein in the disposing of the substrate, a plurality of substrates each having the first and second coil layers are multilayered on the lower cover part.

14. The method of claim 11, wherein in the disposing of the upper cover part, at least one cover sheet formed of a magnetic material including the flake shaped metal powder particles is multilayered on the substrate.
